(19) United States
(12) Patent Application Publication
(10) Pub. No.: US 2004/0103422 A1
(43) Pub. Date: May 27, 2004

(54) Hybrid recording device (HRD) with magneto-resistance head on optically assisted media

(75) Inventor: Ga-Lane Chen, Fremont, CA (US)

Correspondence Address: James Sheridan, MOSER, PATTERSON & SHERIDAN, L.L.P., Suite 100, 595 Shrewsbury Ave., Shrewsbury, NJ, 07702-4184, US

(73) Assignee: Seagate Technology LLC

(21) Appl. No.: 10/693,762

(22) Filed: Oct. 22, 2003

Related U.S. Application Data
(63) Continuation of application No. 09/272,940, filed on Mar. 18, 1999, now abandoned.
(60) Provisional application No. 60/078,557, filed on Mar. 19, 1998.
(60) Provisional application No. 60/078,558, filed on Mar. 19, 1998.

(51) Int. Cl. G11B 7/24; G11B 11/00; G11B 5/02; G11B 5/127; G11B 5/33

(52) U.S. Cl. 720/719; 360/59; 720/658; 369/13.02; 360/313

(57) ABSTRACT

A storage system comprising a magneto resistance sensor for reading and writing information to a storage disk is provided. The storage disk is comprised of multi-layer media or optically assisted media. The storage disk includes an overcoat and lubricant disposed on a top surface of the media.

### RELATED APPLICATIONS

This application claims priority from provisional patent application Serial No. 60/078,557 filed Mar. 19, 1998, and provisional patent application Serial No. 60/07,558 filed Mar. 19, 1998, the entire disclosures of both applications are hereby incorporated herein by reference.

### FIELD OF THE INVENTION

The field of this invention is storage systems. More particularly, the invention pertains to a hybrid magnetic recording device having a magneto-resistance sensor or “head” and optically assisted media.

### BACKGROUND OF THE INVENTION

With the advance of magnetic recording (MR) technology, the design of new MR sensors or “heads” in magnetic recording data storage systems have been the subject of great interest. One area of study is based on the principle of giant magneto-resistance (GMR) which has been observed in certain magnetic multilayered structures. GMR shows a pronounced magneto-resistance effect, and new GMR heads have been produced. In general, GMR heads employ a stack of ferromagnetic layers separated by magnetic or anti-ferromagnetic metal layers. The alternate ferromagnetic layers are magnetized in opposite directions. The nonmagnetic or antiferromagnetic materials induce a spin dependent electron scattering at the layer interfaces. The magnetic flux causes a change in the magnetic resistance which is much greater than with traditional MR sensors, hence, the term giant MR.

Recently, GMR technology has been employed in the design of storage systems. Storage systems using giant magneto-resistance (GMR) heads with high coercivity storage media or disks, can reach areal density of 5 to 10 gigabits/in². One popular reader element design for the GMR head is made of the spin valve device. The writer element of a GMR head is typically made of high saturation moment (Bsat) material with strong inductive flux (i.e. Bsat of approximately: 16,000 to 21,000 gauss). The media used with the GMR head (called “GMR media”) is typically comprised of a high coercivity material.

Generally, the GMR media are longitudinal recording disks having a composition of CoCrPtTaX, where X═Nb, B, Mo, with a coercivity of approximately 3000 to 3500 Oe, and Mrt from approximately 0.4 to 0.6 memu/cm² (where Mrt=remanence×thickness). GMR media however, suffer from certain limitations. For example, GMR media exhibit a superparamagnetic limit for thin magnetic layers. Further the disks are difficult to manufacture and to produce stable magnetic layers with a Mrt of less than 0.5 memu/cm². Thin, longitudinal GMR media are also subject to severe thermal stability and magnetization decay issues.

An alternative type of technology utilized in storage systems is magneto-optical technology. Conventional magneto-optical (MO) technology uses laser beams to write and read information to a MO media or disk. The MO storage system operates on the principle of Curie temperature and Kerr effect as opposed to the magnetic resistance principles of the MR storage systems. Typically, commercial MO media are only coated on a single-side with the laser beam shone through a transparent substrate. Optically assisted Winchester (OAW) technology has been developed where the laser beam is shone through the first thin film surface. To achieve higher density recordings with such systems, the spacing between the sensor head and the disk has to be reduced. That is, it is desirable to place the MO head as close as possible to the surface of the MO disk. As the head to disk spacing is reduced, the head fly height decreases, and the head to disk interface (HDI) becomes very critical. Conventional magneto-optical (MO) media designs do not employ lubricants and/or carbon overcoats, as is commonly used with MR media. Without such lubricants and/or carbon overcoats, MO media exhibit poor tribological performance, and as the HDI is reduced the MO storage systems lack reliability. Further, to permit flying of the MO head close to the disk, a low fly height slider is required. The MO head design is bulky due to the optics required, and the MO head with the constant low fly height slider is very difficult to manufacture. Even more difficult is to employ an optical head stack assembly with multiple platters as known in the art, at low flying heights which is very complicated and expensive.

Thus, it is desirable to provide a storage system which addresses the aforementioned limitations of a conventional magneto optical type head, and a conventional magneto resistance type disk.

### OBJECTS AND SUMMARY OF THE INVENTION

Accordingly, it is an object of the present invention to provide an improved storage system or recording device.

More particularly, it is an object of the present invention to provide a hybrid recording device; that is, a magnetic recording device having a magneto-resistance sensor or head and a multilayer media or optically assisted media.

A further object of the present invention is to provide an improved multilayer media or optically assisted media.

Another object of the present invention is to provide an improved optically assisted media for use with a magneto-resistance sensor, and particularly a giant magneto resistance sensor.

Yet another object of the present invention is to provide a storage system capable of reaching areal density of equal to or greater than 10 Gbits/in², and preferably of 10 to 40 Gbits/in².

These and other objects and advantages are achieved by the present invention disclosed herein where a storage system is provided, comprising a magneto resistance sensor for reading and writing information to a storage disk, and the storage disk is comprised of a multilayer media or optically assisted media.

### BRIEF DESCRIPTION OF THE DRAWINGS

Additional objects and features of the invention will become more clearly apparent from the following detailed description and appended claims when taken in conjunction with the drawings, in which:

FIGS. 1a and 1b are cross-section views of a storage system head and disk, in accordance with one embodiment of the present invention.

FIGS. 2a and 2b are cross-section views of a storage system head and disk, in accordance with an alternative embodiment of the present invention.

FIGS. 3a and 3b are cross-section views of a storage system head and disk, in accordance with an alternative embodiment of the present invention.

FIGS. 4a and 4b are cross-section views of a storage system head and disk, respectively, in accordance with a variation of the alternative embodiment of the present invention.

### DETAILED DESCRIPTION OF THE INVENTION

The inventor has discovered an improved storage system design that employs both MR and MO principles. In great contrast to the prior art where the two fields are quite distinct and independent in their research and application, the present invention is a new way of thinking that advances the art in a new direction.

Given the above limitations, the inventor has evaluates a technology called Lubricated/Overcoated Optically Assisted Winchester (LOAW) technology. LOAW is thought to be capable of reaching higher areal densities than conventional hard disk drives, which exhibit superparamagnetic limits. LOAW can utilize plastic substrates which are light and relatively inexpensive to manufacture. Pre formatted servo patterns may be formed on the surface of the plastic substrate, further simplifying their manufacturability. Further Double-Sided Lubricated/Overcoated Optically Assisted Winchester (DSLOAW) media have double sided coating (that is, the substrate is coated on both sides) with multi-layers, plus an overcoat layer and a lubrication layer.

In the present invention, the inventor employs magneto resistance (MR), and preferably giant magneto resistance (GMR), head technology with optically assisted media technology. This new form of technology is given the name “Hybrid Recording Technology” (HRT), and the storage system device is called “Hybrid Recording Device” (HRD). The Hybrid Recording Device of the present invention overcomes fundamental difficulties of the optical head and MR media in prior art systems. Advantages of the present invention include: the media of the present invention does not suffer from superparamagnetic issues. By contrast, in prior art systems, the coercivity and magnetic moment of conventional GMR media will collapse as their thickness approaches less than 100 Å and the grain size approaches less then 75 Å. In the present invention, the media employs an amorphous structure design which does not exhibit superparamagnetic problems. Due to its perpendicular anisotropy, the media of the present invention has less thermal decay and thermal stability issues, which is a big concern for conventional GMR media. The Hybrid Recording Device of the present invention uses MR sensor or head technology, and preferably GMR head technology. In contrast, magneto-optical (MO) heads, either with solid immerse lens (SIL) or optical fiber, face a big challenge regarding tribology induced optical detection. The MO signal and ROM signal will be strongly affected by contamination of the head to disk interface which commonly occurs, and by variations in fly height. Further, the optical head stack assembly with multiple platters could be very complicated and expensive, especially for high density low fly height disk drives.

The media employed by the present invention is of the MO type, and can use plastic substrates which are less expensive and light, and may be pre-formatted with servo patterns on the plastic surface, providing further ease of manufacturability. Conversely, conventional GMR media require servo patterns which must be electronically formed.

To increase the data rate and rotation speeds, the present invention preferably employs a GMR head. By using a GMR head, the data rate and rotation speed will increase and the seek time will be reduced. A high data rate is necessary for high performance data storage devices. The hybrid device of the present invention can meet this requirement.

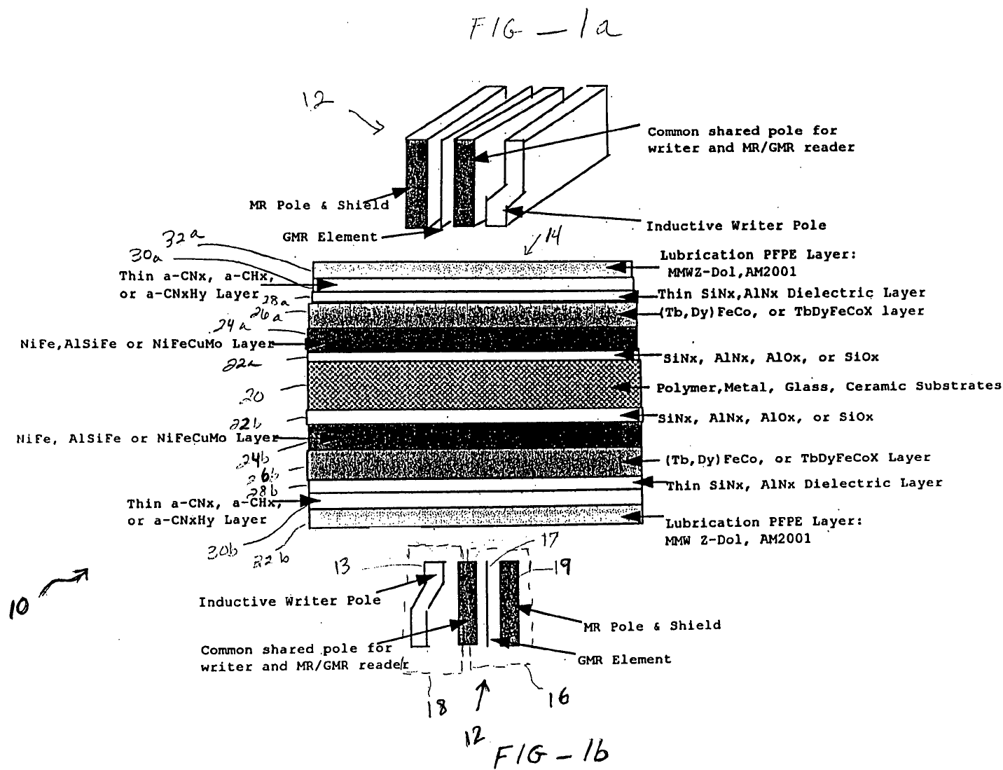

FIGS. 1a and 1b illustrate a hybrid recording device (also called a hybrid storage system) 10 according to one embodiment of the present invention. As shown in FIGS. 1a and 1b, the invention comprises a GMR head 12 and a disk or media 14. The disk 14 is comprised of a substrate and a number of layers formed atop the substrate. Preferably, the media is double sided hex-layer disk with mirror symmetry to the substrate, somewhat similar to a LOAW disk. The GMR head 12 is shown in greater detail in FIG. 1b. Generally, the head 12 is comprised of a reader 16 and a writer 18. The writer of the GMR head is made of high saturation moment (Bsat) material such as NiFeCoX or FeAlN or FeRhN, where X═N or B; with strong inductive magnetic flux (i.e. Bsat=4πMs=about 16,000 to 21,500 gauss, and where Bsat for FeAlNi is 21,000 gauss, and FeGrN can reach a Bsat of 21,500 gauss) to write high coercivity media. The reader element is made of GMR material such as NiFe. There are three kinds of GMR sensor head designs available in the prior art: (1) a spin valve design, (2) a multilayer design, and (3) a granular alloy system design. Any one of these GMR heads may be employed in the present invention.

In one exemplary embodiment of the present invention, the spin valve reader design is used for the GMR head and typically has a structure comprised of multiple layers, such as: Ta/NiFe/Co(or CoFe)/Cu/Co(or CoFeB)/NiFe/exchange bias layer. The exchange bias layer is selected from the group consisting of: FeMn, IrMn, NiCoMn, NiCoO, ThCo, and NiO. In an exemplary embodiment, the spin valve reader is comprised of the structure: 50 Å Ta/100 Å A NiFe (the free rotation layer)/25 Å Co/25 Å Cu/25 Å Co/25 Å NiFe (the pinned layer)/100 Å FeMn (the exchange layer). If the uniaxial anisotropy hard axis of the free layer is oriented along the transverse direction, the magnetic GMR signal will be linear.

In another embodiment of the present invention the multilayer reader design is used. The multilayer reader design is generally comprised of magnetic and nonmagnetic layers, such as: (Fe/Cr)n, (Fe/Cu)n, (NiFe/Ag)n, or (CoFe/Cu)n, where n is in the range of about 20 to 40, and most usually around 30. And in yet another embodiment of the present invention the granular alloy system reader design is used. The granular alloy system reader design is generally a heterogeneous system such as: Co—Cu, Co—Au, Co—Ag, Fe—Cy, or Fe—Ag. In the exemplary embodiment shown in the figures, the GMR head 12 illustrated in FIG. 1a is made of a spin valve device; however, it is to be understood that the present invention is not limited and any one of the three designs and their variations may be employed.

The GMR head 12 generally includes an inductive writer pole 13, a common shared pole 15 for writer and reader, a MR element 17, and a MR pole and shield 19. According to one embodiment of the present invention, for the GMR head 12 exhibiting a recording density of 10 Gbit/in², preferably the reader gap is approximately 0.16 micron. The read track width is approximately 0.45 micron. Preferably, the MR element 17 has a thickness of approximately 65 Å and a height of approximately 0.38˜ to 0.42 micron, and preferably 0.40 micron. The spacing between the MR element 17 and MR pole and shield 19 is approximately 800 Å.

The disk 14 according to one embodiment of the present invention is illustrated in FIG. 1a. Preferably, the disk 14 is double-sided, that is layers are sputtered on both sides of a substrate, however in an alternative embodiment the disk may be one sided. Specifically, the disk 14 is comprised of a substrate 20 and atop the substrate are formed a plurality of layers. In the exemplary embodiment, the total number of layers, including the substrate, is thirteen. However, it should be understood by those of ordinary skill in the art, that any appropriate number of layers may be used.

The substrate 20 may be comprised of a variety of materials, such as polymer, metal, glass, ceramics or glass-ceramics. Preferably, the substrate is comprised of glass or glass-ceramics. When the disk is a double sided disk, the layers formed atop the substrate 20 are mirror images, that is, the layers and their sequence are the same on both sides of the substrate. Thus, the description herein refers to the layers as a first layer, a second layer, and so on, but it is to be understood that there are two first layers, that is one first layer on each side of the substrate. A first layer 22a and 22b is formed atop both sides of the substrate 20. The first layer 22a and 22b is a protective layer, such as a reactive sputter dielectric layer. The first layer 22a and 22b is comprised of a dielectric material selected from the group consisting of: silicon nitrides (SiNx), aluminum nitrides (AlNx), silicon oxides (SiOx), and aluminum oxides (AlOx). Preferably, the first layer is comprised of SiNx. This dielectric layer is useful for preventing oxygen and water vapor from the substrate and outside environment from entering the memory layer. The second layer 24a and 24b is a magnetic layer comprised of a soft-magnetic material, such as NiFe, AlSiFe, NiFeCuMo, and the like. This second layer 24a and 24b provides for the magnetic flux return during recording with the head 12. A third layer 26a and 26b is formed atop the second layer. The third layer is a hard magnetic layer comprised of a rare-earth/transition metal (RE-TM) material, such as TbFe, TbFeCo, DyFeCo, (Th, Dy)FeCoX, where X is Al, Y, or Nd, and the like. This third layer 26a and 26b exhibits perpendicular anisotropy and high coercivity at room temperature. Preferably, the third layer is comprised of TbFeCo, and has a coercivity in the range of approximately 3000 to 5000 Oe. This RE-TM layer 26a and 26b exhibits very good magnetic squareness “S” (preferably S is in the range of approximately 0.85 to 1.0) for M-H loop in the perpendicular direction. Atop the RE-TM layer is formed a fourth layer 28a and 28b that is a thin passivation layer comprised of a dielectric such as silicon nitrides (SiNx), aluminum nitrides (AlNx), silicon oxides (SiOx), aluminum oxides (AlOx), and the like, with a thickness in the range of approximately 50 Å to 100 Å. Formed atop the passivation layer 28a and 28b, is a fifth layer 30a and 30b which acts as an overcoat layer. Preferably the overcoat layer 30a and 30b exhibits good tribology properties and is a thin amorphous diamond like carbon (DLC) layer, such as a-CNₓ (where x is in the range of about 5% to 30%), a-CHₓ (where x in the range of about 20% to 30%), or a-CNxHy (where x in the range of about 3% to 10%, and y in the range of about 15% to 27%), and having a thickness in the range of approximately 50 Å to 100 Å. To permit low flying heights, the disk of the present invention employs a lubrication layer as a sixth layer 32a and 32b atop the overcoat layer 30a and 30b. Preferably the lubrication layer 32a and 32 b includes a PFPE lubricant, such as commercially available lubricants Z-Dol, AM2001, and the like.

Of particular advantage, and in contrast to the prior art, the media of the present invention satisfies multiple purposes by providing desirable magnetic, as well as tribological properties. Of further advantage, the storage system of the present invention can achieve the following criteria: at a recording density of 10 Gbit/in², the fly height and glide height of head on this media can be as low as 25 nm and 12.5 nm, respectively, when using negative pressure on the air bearing surface of the head slider. At a recording density of 40 Gb/In², the fly height and glide height can be as low as 12.5 nm and 6.5 nm, respectively.

To read and write using the present invention, the “inductive” principle is used to write, and the “magneto resistance” or giant magneto resistance principle is used to read. In the writing process, the writing flux is produced either from the inductive writer pole 13 to the common shared pole for writer and reader 15, or from the common shared pole 15 to the inductive writer pole 13, depending upon the polarity of the writing current. The magnetic flux produced from the pole crosses the air gap and reaches the media 14 and returns to the other pole with a recording circle (or semi-circle).

In the reading process, as the media passes under the GMR element 17, the GMR element 17 will change its electrical resistance, ΔR. The readout signal (or voltage) of the GMR head is proportional to the change of electrical resistance, which is sensitive to the magnetic field from the media. While the read and write process has been described with reference to the embodiment of the invention illustrated in FIGS. 1a and 1b, the process is the same for the other embodiments of the invention.

GMR head uses an inductive writer pole and the common shared pole to write to the media.

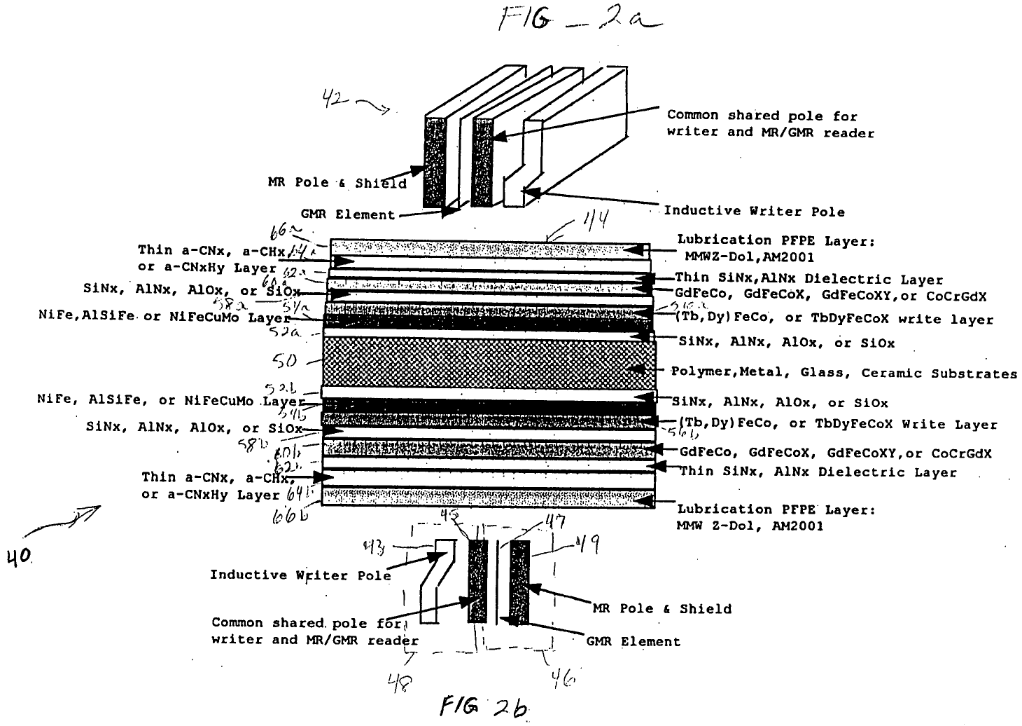

An alternative embodiment of the present invention is shown with reference to FIGS. 2a and 2b. As shown in FIG. 2a and 2b, the inventive storage system 40 comprises a GMR head 42 and a disk or media 44. The disk 44 is comprised of a substrate and a number of layers. Preferably the disk 44 is a double sided eight layer disk with mirror symmetry to the substrate. The head 42 is shown in greater detail with reference to FIG. 2b. Generally, the head 42 is comprised of a reader 46 and a writer 48. The reader 46 of the head 42 is preferably made of the spin valve type device as described in detail above having an inductive writer pole 43, a common shared pole 45 for writer and reader, a MR element 47, and a MR pole and shield 49. However, other types of heads are suitable as described above. The writer 48 of the head 42 is preferably made of high saturation moment (Bsat) material with strong inductive flux (where Bsat is in the range of approximately 16,000 to 21,000 gauss) to write to high coercivity media.

The disk 44 according to an alternative embodiment of the present invention is shown in FIG. 2b. Preferably, the disk 44 is double-sided, however it is to be understood alternatively that the disk could be single sided. In this exemplary embodiment, the total number of layers, including the substrate is seventeen. Specifically, the disk 44 is comprised of a substrate 50 and atop the substrate 50 are formed the plurality of layers.

The substrate 50 may be comprised of a variety of materials, such as polymer, metal, glass, ceramics, or glass-ceramics and preferably is comprised of glass or glass-ceramics. When the disk 44 is a double sided disk, the plurality of layers are formed atop the substrate 50 as mirror images, and are formed by known techniques. A first layer 52a and 52b is formed atop both sides of the substrate 50. The first layer 52a and 52b is a protective layer, such as a reactive sputter dielectric layer, and is preferably selected from the group consisting of: silicon nitrides (SiNx), aluminum nitrides (AlNx), silicon oxides (SiOx), and aluminum oxides (AlOx). This dielectric layer prevents oxygen and water vapor from the substrate and outside environment from contaminating the memory layer. The second layer 54a and 54b is a magnetic layer comprised of a soft-magnetic material, such as NiFe, AlSiFe, NiFeCuMo, and the like. This second layer 54a and 54b acts as the magnetic flux return layer during inductive write/spin valve readback with the head 42. A third layer 56a and 56b is formed atop the second layer 54a and 54b and is a hard magnetic layer comprised of a rare-earth/transition metal (RE-TM) layer, such as TbFe, TbFeCo, DyFeCo, or (Th, Dy)FeCoX and the like, where X is Al,Y, or Nd. This third layer 56a and 56b exhibits perpendicular anisotropy and has high coercivity at room temperature. Preferably, the third layer 56a and 56b has a coercivity in the range of approximately 3000 to 5000 Oe at room temperature. This RE-TM layer 56a and 56b exhibits very good magnetic squareness (preferably S is in the range of approximately 0.85 to 1.0) for M-H loop in the perpendicular direction. Next, a fourth layer 58a and 58b is formed atop the third layer, and acts as a spacer layer between the write and read layers 56a 56b, and 60a 60b respectively. Preferably, the fourth layer 58a and 58b has a thickness in the range of approximately 10 Å to 50 Å. Suitable materials from which the fourth layer is formed include Cr, silicon nitrides (SiNx), aluminum nitrides (AlNx), or CrX, where X is selected from the group consisting of: V, Mn, and Ti. A fifth layer 60a and 60b which is a readout layer, is formed atop the fourth layer 58a and 58b. The readout layer 60a and 60b has a preferred coercivity in the range of approximately 2000 Oe to 3000 Oe at room temperature. The readout layer 60a and 60b is preferably comprised of a material selected from the group consisting of: GdFeCo, GdFeCo, GdFeCoX, GdFeCoXY, where X═Al,Nd or Y, and Y is Cr, Ta or Nb, and amorphous CoCrGdX, where X is Al. This layer provides super resolution for the individual magnetic bits in the readback process. Next, a sixth layer 62a and 62b is formed atop the readout layer 60a and 60b and functions as a thin passivation layer. The passivation layer 62a and 62b is preferably comprised of silicon nitrides (SiNx), aluminum nitrides (AlNx), silicon oxides (SiOx), or aluminum oxides (AlOx); with a thickness in the range of approximately 50 Å to 100 Å. A seventh layer 64a and 64b is formed atop the passivation layer and functions as a very thin tribology layer. Preferably the tribology layer 64a and 64b is comprised of an overcoat amorphous diamond like carbon (DLC) layer, such as a-CNₓ (where x in the range of about 5% to 30%), a-CHₓ (where x is in the range of about 20% to 30%), or a-CNxHy (where x is in the range of about 3% to 10%, and y is in the range of about 15% to 27%), with a thickness in the range of about 50 Å to 100 Å. An eighth layer 66a and 66b comprised of a lubrication layer is formed atop the tribology layer 64a and 64b. Preferably the lubrication layer 66a and 66b includes a PFPE lubricant such as commercially available Z-Dol, AM2001, and the like. This design has multi-function for both magnetic as well as tribological properties. The fly height of a head on this media can achieve spacings as low as 25 nm with negative pressure design on the air bearing surface of the head slider. In great contrast, conventional MO media crashed immediately at fly heights of less than 15 microinches.

In great contrast to the prior art, the storage system and media of the present invention exhibits excellent tribological properties at low fly heights. The fly height with this media can be as low as 12.5 nm (0.5 microinches) for an areal density of 40 Gb/in². In one exemplary embodiment, for the GMR head design at density of 40 Gb/in², the reader gap is 0.07 micron. The read trackwidth is 0.45 micron. The MR element has a thickness of 25 Å and height of 0.2 micron. The spacing between MR element and shield is 350 Å. Three PFPE lubricants were used: MMW Z-Dol, HMW Z-Dol, and AM 2001, each tested with thicknesses of 15 Å, 20 Å and 25 Å. HMW Z-Dol at 15 Å and 20 Å did not exhibit good performance with this media and severely scratched the media surface during flying tests on the MR head slider. HMW Z-Dol at 25 Å also exhibited light scratches on the flying test. Both MMW Z-Dol and AM2001 showed good lubrication performance with this media and were able to pass flying tests for lubricant thicknesses at 15 Å, 20 Å, and 25 Å. MMW Z-Dol showed the best tribological performance.

The MMW Z-Dol lubricant has a medium molecule distribution in the range of 2000 to 4000 AMU. Thicknesses of 25 Å to 30 Å provide excellent tribology performance for the two hybrid recording device embodiments of the present invention shown in FIGS. 1a and 2a.

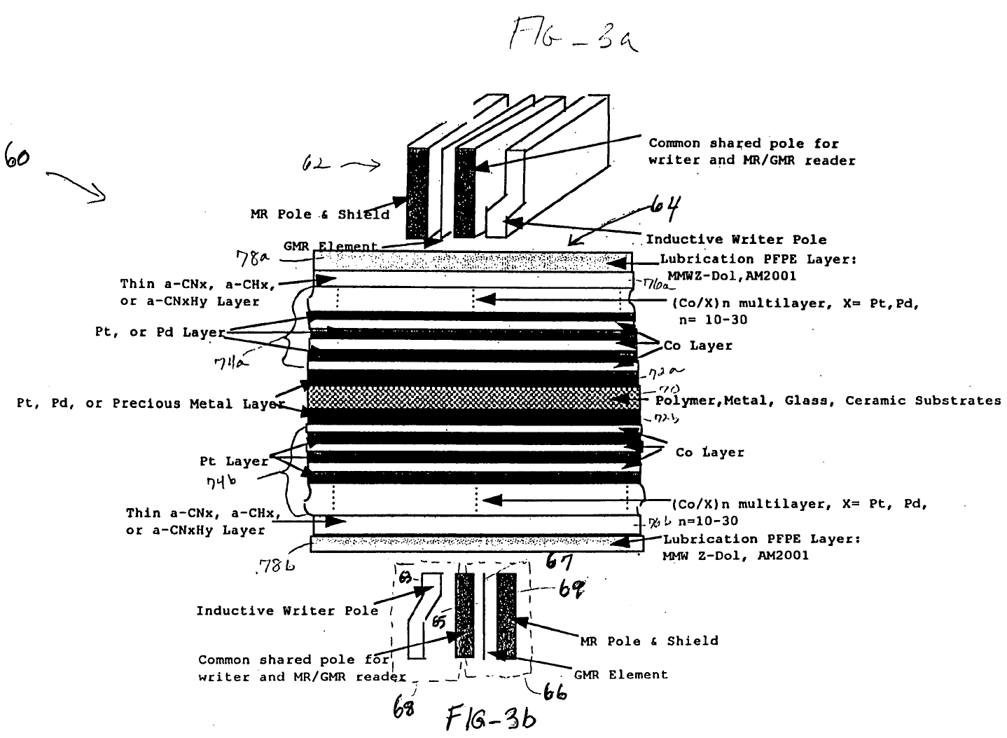

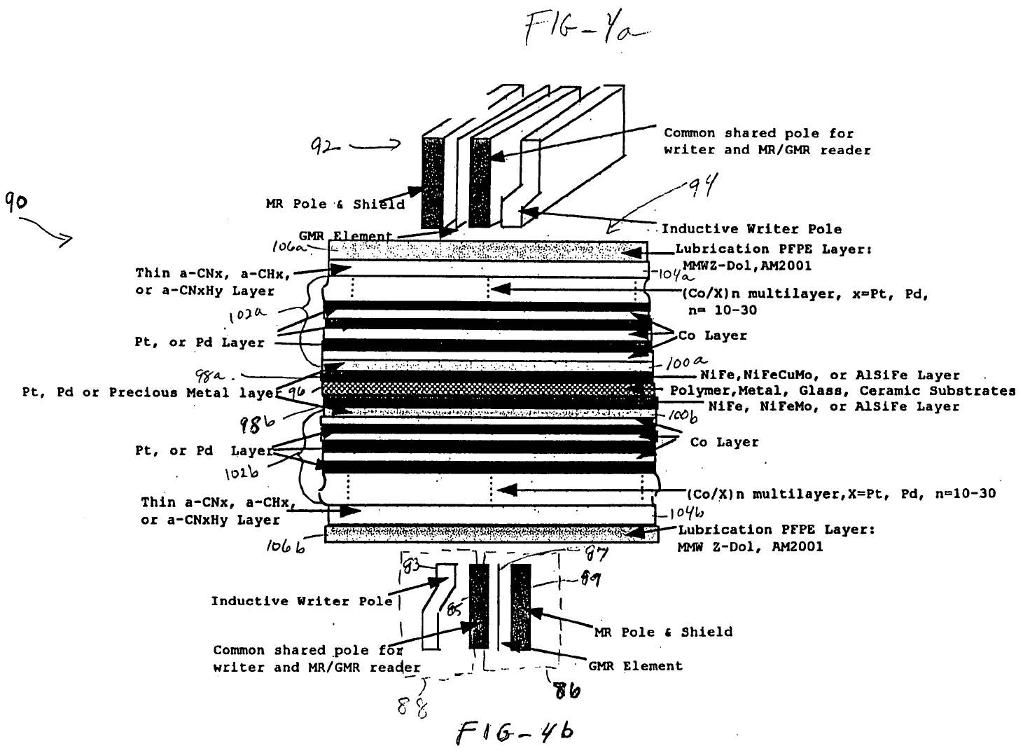

An alternative embodiment of the present invention is shown in FIGS. 3 and 4. In this embodiment, a MR head as described above is used with optically assisted media; however, in this case the optically assisted media is a superlattice multilayer type media.

Specifically, longitudinal MR media exhibit severe problems with thermal stability and magnetization decay. Perpendicular recording media with a small demagnetization factor exhibit better thermal stability and less magnetization decay than longitudinal media at higher recording density. Co/Pt superlattice multi-layer (SLM) films have bigger Kerr rotation angle for the wavelength of blue light laser than shown for TbFeCo media. Researches have reported (Co/Pt)n multi-layer as one of the candidates for future high density magneto-optical recording media in the literature. No one has reported the use of (Co/Pt)n as MR media.

The inventor has reported the used of (Co/Pd)n and (Co/Pt)n multi-layer media and tested the same with an MR head and achieved good recording performance as disclosed in U.S. Pat. No. 5,750,270 issued May 12, 1998 entitled “MULTI-LAYER MAGNETIC RECORDING MEDIA” by Xiaoxia Tang and Ga-Lane Chen, the entire disclosure of which is hereby incorporated by reference.

In this embodiment of the present invention, the MR head or sensor is the same as described above, and preferably is comprised of the spin valve type. In this case the media or disk employed is comprised of a superlattice multilayer media (SLM), and preferably a lubricated and overcoated superlattice multilayer media (LOSLM). This embodiment is depicted in FIGS. 3 and 4. Conventional magneto-optical (MO) media design without a lubricant and carbon overcoat will have poor tribological performance and lack of reliability for optical storage systems. Superlattice multilayer media, and preferably lubricated and overcoated superlattice multilayer media of the present invention, is capable of reaching higher areal densities than prior art systems. The storage system of the present invention can reach areal densities up to 40 Gb/in² or higher. Of further advantage, the media of the present invention can employ less expensive and light plastic substrates with preformatted servo patterns formed on the surface of the plastic substrate, as opposed to conventional MR media which requires electronically servo patterns. The superlattice multilayer media of the present invention overcomes the superparamagnetic issues with the prior art. The inventive media has a superlattice multilayer design with perpendicular anisotropy exceeding 2×10⁶ erg/cm³ and coercivity as high as 5000 Oe to avoid superparamagnetic problems. Due to its strong perpendicular anisotropy, the superlattice multilayer media has less thermal decay than exhibited by conventional longitudinal media. By employing a MR head, and preferably a GMR head, and the superlattice multilayer media, according to this embodiment of the storage systemrof the present invention the data rate and rotation speed will increase and the seek time can be reduced. High data rates are necessary for high performance storage system devices. Further, by employing a negative air pressure design on the air bearing surface of the head slider, the fly height of the storage system of the present invention can get as low as 0.5 microinches and achieve an areal density of 40 Gb/in² using a narrow gap GMR head at 0.07 microns and lubricated and overcoated superlattice multilayer media with coercivity up to 5000 Oe.

FIGS. 3a and b and 4a and b show two variations of a hybrid storage system device 60 according to this embodiment of the present invention. Specifically, as shown in FIGS. 3a and 3b the invention comprises a GMR head 62 and a superlattice multilayer disk or media 64. Preferably, the disk 64 is comprised of a lubricated and overcoated superlattice multilayer media having a substrate and a number of layers. Preferably, the media is double sided with mirror symmetry to the substrate.

The GMR head 62 is preferably comprised of a spin valve device having a reader 66 and a writer 68. The writer 66 of the GMR head is made of high saturation moment (Bsat) material, such as NiFeCoX, where X is N or B, FeAlN or FeRhN with strong inductive flux (Bsat of about 16,000 to 21,000 gauss) to write high coercivity media. The reader element 66 is preferably made of GMR material. Preferably the GMR sensor head design is a spin valve design having a structure of: Ta/NiFe/Co/Cu/NiFe/Exchange bias layer. The exchange bias layer may be selected from any one of: Fen, IrMn, NiCoMn, NiCoO, ThCo, or NiO. In one exemplary embodiment, the layer thickness is as follow: 50 Å Ta/100 Å NiFe (free rotation layer)/25 Å Co/25 Å Cu/25 Å NiFe (pinned layer)/100 Å FeMn. If the uniaxial anisotropy hard axis of the free layer is oriented along the transverse direction, the magnetic GMR signal will be linear.

Other types of GMR head designs are also suitable with the present invention. For example a multilayer design with magnetic and nonmagnetic layers, such as (Fe/Cr)n, (Fe/Cu)n, (NiFe/Ag)n or (CoFe/Cu)n may be used. Further, a granular allow system such as Co—Cu, Co—Au, Co—Ag, Fe—Cu and Fe—Ag heterogeneous systems may be employed as the head design.

Turning back to the spin valve GMR head design shown in FIGS. 3 and 4, the head 62 generally includes an inductive writer pole 63, a common shared pole 65 for writer and reader, a MR element 67, and a MR pole and shield 69. For a GMR head design at density of 10 Gbit/in², the reader gap is about 0.16 microns. The read trackwidth is about 0.45 microns. The MR element has a thickness of about 65 Å and a height of about 0.4 microns. The spacing between the MR element and the shield is about 800 Å. The invention can reach 40 Gbits/in² with a fly height at 12.5 nm and reader gap of about 0.07 microns.

This disk according to one variation of this alternative embodiment of the present invention is illustrated in FIG. 3a. Preferably, the disk 64 is double-sided, that is the layers are formed on both sides of a substrate; however, in an alternative embodiment the disk may be one sided. Specifically, the disk 64 is comprised of a substrate 70 and atop the substrate are formed a plurality of layers.

The substrate 70 may be comprised of a variety of materials, such as polymer, metal, glass, ceramics, or glass-ceramics. Preferably, the substrate 70 is formed of glass or glass-ceramics. When the disk 64 is a double sided disk the layers formed atop the substrate 70 are mirror images, that is the layers and their sequence are the same on both sides of the substrate. A first layer 72a and 72b is formed atop both sides of the substrate 70. The first layer 72a and 72b is a precious metal layer having a thickness of about 100 to 300 Å. The first layer may be comprised of Pt, Pd, and the like. Optionally, although not shown on the figures, a dielectric layer such as silicon nitride (SiNx), aluminum nitride (AlNX) and the like, may be sputtered on the surfaces of the substrate as a seed layer to prevent oxygen and water vapor from contacting the substrate 70. Next, a series of superlattice multilayers are formed atop the first layer 72a and 72b, and are collectively referred to as a second layer 74a and 74b. For purposes of this description these multilayers are referred to as second layer 74a and 74b, however it is to be understood that this second layer is comprised of multiple layers. Specifically, the second layer 74a and 74b is comprised of superlattice multilayers comprised of a combination of Co, and Pt or Pd layers, where the Co layers are placed in between either the Pt or Pd layers, such as for example the structure: (Co/Pt)n or (CoPd)n, and where n is about 10 to 30. Preferably, the thickness of the Co layers is in the range of about 3 to 5 Å, and the thickness of the Pt or Pd layers are in the range of about 7 to 10 Å. This superlattice multilayer media of the present invention has very high perpendicular anisotropy, generally exceeding 2×10⁶ erg/cm³ and coercivity as high as 5000 Oe to avoid superparamagnetic problems. The squareness ratio S is in the range of 0.85 to 1.0 for M-H loop measured in the perpendicular direction.

A third layer 76a and 76b is formed atop the superlattice multilayer 74a and 74b. The third layer 76a and 76b is an overcoat layer preferably comprised of a thin tribology-overcoat amorphous diamond-like (DLC) layer such as a-CNₓ (where x is in the range of about 5% to 30%), a-CHₓ (where x is in the range of about 20% to 30%), or a-CNxHy (where x is in the range of about 3% to 10%, and y is in the range of about 15% to 27%), with a thickness in the range of about 50 to 100 Å.

A fourth layer 78a and 78b is formed atop the overcoat layer 76a and 76b. The fourth layer 78a and 78b is a lubricant layer and is preferably includes a PFPE lubricant such as commercially available Z-Dol, AM2001 and the like, with a thickness in the range of about 25 to 30 Å. The lubricant layer 78a and 78b may be applied to the disk surface by conventional processes, such as a dipping process. The concentration of the lubricant in the lubricant layer 78a and 78b is preferably in the range of about 0.2 to 0.3 weight %, with the balance being a solvent such as C₆F₁₄ (tradename PF5060), C₄F₉OC₂H₅ (tradename HFE-7200), C₄F₉OCH₃ (tradename HFE-7100), C₅H₂F₁₀ (tradename HFC4310), or the like. The bonded lubricant ratio of the lubricant layer 78a and 78b may be enhanced by employing a conventional oven or UV curing process after applying the lubricant. Further, to enhance the glide height yield and reduce the occurrence of surface particles, conventional buffmg (also referred to as tape burnishing) and wiping processes may be used.

Of particular advantage, the present invention provides multiple enhanced functions; namely, the improvement of both magnetic and tribological performance of the storage system. For a recording density at 10 Gbit/in² and negative pressure design on the air bearing surface of the head slider, the fly height and glide height of the head on this media can be as low as 25 nm and 12.5 nm, respectively. Preferably the slider loading mechanism is a ramp-loading design. For a GMR head at a density of 10 Gbit/in², the reader gap is 0.16 microns. The trackwidth is 0.45 microns. The MR element has a thickness of 65 Å and a height of 0.4 microns. The spacing between the MR element and shield is 800 Å.

FIGS. 4a and 4b illustrate an alternative embodiment of the present invention depicting a storage system with a superlattice multilayer media and a MR head. The storage system 90 again includes a GMR head 92 and a superlattice multilayer media 94. The GMR head 92 is preferably comprised of a spin valve device having a reader 86 and a writer 88, as described above. The writer of the GMR head 92 is made of high saturation moment (Bsat) material with strong inductive flux (Bsat: 16,000 to 21,000 gauss) to write high coercivity media. The GMR head 92 generally includes an inductive writer pole 83, a common shared pole 85 for writer and reader, a MR element 87, and a MR pole and shield 89. For a GMR head design at a density of 40 Gb/in², the reader gap is about 0.07 microns. The read trackwidth is about 0.45 microns. The MR element has a thickness of about 25 Å and a height of about 0.2 microns. The spacing between the MR element and shield is about 350 Å.

The medium 94 is preferably double sided; however, single sided media can also be used. The media 94 is generally comprised of a substrate 96 having formed thereon a plurality of layers. The substrate 96 is formed of a polymer, metal, glass, ceramic or glass-ceramic material. Preferably, the substrate 96 is made of glass or glass-ceramic. When the disk is double sided the layers formed atop the substrate 96 are mirror images, that is the layers and their sequence are the same on both sides of the substrate. A first layer 98a and 98b is formed atop the substrate 96. The first layer 98a and 98b is formed of NiFe, NiFeCuMo, or AlSiFe, a soft magnetic layer for the magnetic flux return during recording. A second layer 100a and 100b is formed atop the soft magnetic layer 98a and 98b. The second layer 100a and 100b is preferable a precious metal layer such as Pt, Pd, and the like. The second layer 100a and 100b has a thickness of the range of about 100 to 300 Å. Although not shown, a dielectric layer such as silicon nitride (SiNx) or aluminum nitride (AlNx) may be formed in between the substrate 96 and the first layer (made of NiFe, NiFeCuMo, or AlSiFe layer) to prevent oxygen and water vapor from contaminating the substrate 96. Then, a series of superlattice multilayers are formed, collectively referred to as a third layer 102a and 102b. Specifically, the superlattice multilayers are formed of a series of Co, and Pt or Pd layers, having the structure: (Co/Pt)n or (Co/Pd)n where n is 10 to 30. Thus, the layers are formed in alternating series, that is Co/Pt or Pd/Co/Pt or Pd/Co and so on. Preferably, the thickness of the Co layer is in the range of about 3 to 5 Å, and the thickness of the Pt or Pd layers is in the range of about 7 to 10 Å. This superlattice multilayer 102a and 102b exhibits very high perpendicular anisotropy exceeding 2×10⁶ erg/cm³ and coercivity as high as 5000 Oe to avoid superparamagnetic problems. The squareness ratio S is designed to be in the range of about 0.85 to 1.0 for M-H loop measured in the perpendicular direction.

A fourth layer 104a and 104b is formed atop the superlattice multilayer 102a and 102b. The fourth layer is an overcoat layer preferably made of a thin tribology overcoat amorphous diamond-like (DLC) layer, such as a-CNₓ (where x is in the range of about 5% to 30%), a-CHₓ (where x is in the range of about 20% to 30%), or a-CNxHy (where x is in the range of about 3% to 10%, and y is in the range of about 15% to 27%), with a thickness in the range of about 50 to 100 Å.

A fifth layer 106a and 106b is formed atop the overcoat layer 104a and 104b. The fifth layer 106a and 106b is a lubricant layer and is preferably including a PFPE lubricant such as commercially available Z-Dol, AM2001 and the like, with a thickness in the range of preferably about 25 to 30 Å. The lubricant layer 106a and 106b may be applied to the disk surface by conventional processes, such as dipping process. The concentration of the lubricant in the lubricant layer 106a and 106b is preferably in the range of about 0.2 to 0.3% by weight, with the balance being a solvent such as PFPE50(C₆F₁₄). In this exemplary embodiment, the lubricant layer is comprised of Z-Dol having a medium molecular weight (MMW) distribution in the range of 2000 to 4000 AMU at a thickness of 25 to 30 Å. The bonded lubricant ratio of the lubricant layer 106a and 106b may be enhanced by employing a conventional oven or UV curing process after applying the lubricant. Further, to enhance the glide height yield and reduce the occurrence of surface particles, conventional buffing (also referred to as tape burnishing) and wiping processes may be used.

Of particular advantage, the present invention provides multiple enhanced functions; namely, the improvement of both magnetic and tribological performance of the storage system. The fly height of the head on this media can be very low with a negative pressure design on the air bearing surface of the head slider. The slider loading mechanism is preferably a ramp-loading design. For a recording density at 40 Gbit/in², the fly height of the head on this media can be as low as 12.5 nm (0.5 microinches). In an exemplary embodiment, for the GMR head design at density of 40 Gbit/in², the reader gap is about 0.07 microns. The read trackwidth is about 0.45 microns. The MR element has a thickness of about 25 Å and a height of about 0.2 microns. The spacing between the MR element and shield is about 350 Å.

Three types of PFPE lubricants were tested for the lubricant layers 106a and 106b. They are: MMW Z-Dol, H1MW Z-Dol and AM2001, each with thicknesses of 15, 20 and 25 Å. Z-Dol is a polymer having a structure of: HOH₂C—CF₂—[CCF₂O—CF₂)m-(CF₂O) n]-CF₂O—CHOH with end functional group CH₂—OH. AM2001 has reactive functional groups of:

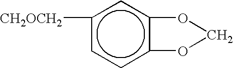

To test the performance of the lubricants, the lubricants were applied on similar media to the present invention with ramp loading mechanisms on the slider disk interface. Test results show that the HMW Z-Dol lubricant at thicknesses of 15 Å and 20 Å did not perform well as a lubricant layer for the superlattice multilayer media of the present invention. Flying tests using the MR head slider resulted in severe scratches on the media surface. The HMW Z-Dol lubricant at a thickness of 25 Å on the superlattice multilayer media also did not perform well, as light scratches were formed on the media surface after fly tests. Both MMW Z-Dol and AM2001 were found to be very good lubricants when employed as the lubricant layer on the superlattice multilayer media of the present invention. Specifically, flying tests using MMW Z-Dol and AM2001 at thicknesses of 15, 20 and 25 Å showed good tribology performance. The lubricant MMW Z-Dol at a thickness of 25 Å exhibited the best tribological performance on the superlattice multilayer media of the present invention. Preferably the slider loading mechanism is a ramp-loading design.

As described the invention combines the advantage of high signal output of a GMR sensor and strong perpendicular anisotropy with good thermal stability of multi-layer media. Further the invention with the GMR sensor gives much higher readout signal than the conventional MO readout by smaller Kerr rotational angle. The invention with its perpendicular multi-layer media overcomes the fundamental limit of superparamagnetics which is exhibited by the conventional longitudinal media. And further, the invention provides good tribiological performance for future data storage devices.

Thus, an improved storage system having a hybrid magnetic recording device has been described. While the present invention has been described with reference to a few specific embodiments, the description is illustrative of the invention and is not to be construed as limiting the invention. Various modifications and changes may occur to those skilled in the art without departing from the true. spirit and scope of the invention as defmed by the appended claims.

1. A storage system comprising:
means for reading and writing information on a storage disk consisting of a magnetic recording head comprising a magneto-resistance sensor (MR); and
means for storing said information in said storage disk, wherein said storage disk comprises a magneto-optical (MO) type media having a diamond like carbon overcoat layer and a lubrication layer formed on at least one surface thereof.

2. The storage system of claim 1 wherein said magneto-optical (MO) type media is comprised of double sided optically assisted Winchester media.

3. The storage system of claim 1 wherein said magneto-optical (MO) type media comprises:
a substrate formed of a material selected from the group consisting of polymer, metal, glass, ceramic, and glass-ceramic;
a dielectric layer formed atop said substrate;
a magnetic layer comprising a soft magnetic material formed atop said dielectric layer;
a hard magnetic layer comprising a rare earth transition metal formed atop said magnetic layer;
a thin passivation layer formed atop said hard magnetic layer;
the diamond like carbon overcoat layer formed atop said thin passivation layer; and
the lubrication layer formed atop said diamond like carbon overcoat layer, said lubrication layer including a PFPE lubricant.

4. The storage system of claim 1 wherein the magnetic recording head comprises a reader and a writer, wherein the reader comprises a giant magneto-resistance (GMR) sensor.

5. The storage system of claim 4 wherein the writer comprises a high saturation moment (Bsat) material, wherein the Bsat is from about 16,000 Gauss to about 21,500 Gauss.

6. The storage system of claim 5 wherein the writer is made of a high saturation moment (Bsat) material selected from the group consisting of NiFeCoX, FeAlN, FeRhN, wherein X is selected from the group consisting of N and B.

7. The storage system of claim 3 wherein said magnetic layer comprises a material selected from the group consisting of NiFe, AlSiFe and NiFeCuMo.

8. The storage system of claim 3 wherein said hard magnetic layer comprises a material selected from the group consisting of TbFe, TbFeCo, DyFeCo and (Tb,Dy)FeCoX, wherein X is selected from the group consisting of Al, Y and Nd.

9. The storage system of claim 3 wherein said lubricant comprises a material selected from the group consisting of Z-DOL, MMW Z-DOL and AM2001.

10. The storage system of claim 1 wherein the magnetic resistance sensor is—comprised of a spin valve.

11. The storage system of claim 10 wherein said spin valve is formed of multiple layers, the multiple layers being comprised independently of Ta, NiFe, Co, Cu, Co NiFe and an exchange bias layer, and wherein said exchange bias layer is selected from the group consisting of FeMn, IrMn, NiCoMn, NiCoO, ThCo and NiO.

12. The storage system of claim 1 wherein said storage disk is comprised of superlattice multilayer media.

13. The storage system of claim 3 further comprising a readout layer formed in between said thin passivation layer and said overcoat layer.

14. The storage system of claim 12 wherein said superlattice multilayer media is comprised of:
a substrate formed of polymer, metal, glass, ceramic or glass-ceramic material;
a first layer made of a precious metal formed atop said substrate;
a series of superlattice multilayers formed atop said first layer, said series being comprised of alternating layers of Co and either Pt or Pd;
an overcoat layer formed atop said superlattice multilayer; and
a lubrication layer formed atop said overcoat layer, said lubrication layer including a PFPE lubricant.

15. The storage system of claim 14 further comprising a soft magnetic layer formed in between said substrate and said series of superlattice multilayers.

16. The disk of claim 13 wherein said readout layer is selected from the group consisting of GdFeCo, GdFeCoX, GdFeCoXY where X is Al, Nd or Y and Y is, Cr, Ta or Nb and CoCrGdX, where X is Al.
